(19) United States
(12) Patent Application Publication
(10) Pub. No.: US 2009/0179546 A1
(43) Pub. Date: Jul. 16, 2009

(54) THIN-SHAPED DISPLAY DEVICE

(76) Inventors: Tsutae Shinoda, Hyogo (JP); Manabu Ishimoto, Hyogo (JP); Kenji Awamoto, Hyogo (JP); Hitoshi Hirakawa, Hyogo (JP)

Correspondence Address: STITES & HARBISON PLLC, 401 COMMERCE STREET, SUITE 800, NASHVILLE, TN, 37219, US

(21) Appl. No.: 12/300,335

(22) PCT Filed: May 10, 2006
(86) PCT No.: PCT/JP2006/309428

§ 371 Date: Nov. 10, 2008

(51) Int. Cl. H01J 1/62; H01J 1/88

(52) U.S. Cl. 313/484; 313/243; 313/511; 313/505

(57) ABSTRACT

A light emitting portion and an electrode board including electrodes for driving the light emitting portion for light emission are provided as separate members. This allows the light emitting portion to have a smaller thickness, and widens the choices of substrate materials for the electrode board. Therefore, a flexible material can be used for the electrode board, thereby imparting the display device with flexibility. Further, the light emitting portion and the electrode board can be separately produced, so that the degree of freedom is increased in the production of the display device. Therefore, the light emitting portion and the electrode board can be produced in different steps or in different production lines. Further, the light emitting portion, the electrode board and other components can be individually evaluated for quality, thereby reducing the production costs of the display device.

### TECHNICAL FIELD

The present invention relates to a display device and, more specifically, to a thin-shaped display device which is produced by separately providing a light emitting portion and a board including electrodes and the like for driving a desired part of the light emitting portion, and combining the light emitting portion with the board.

### BACKGROUND ART

Large-screen thin-shaped display devices are embodied in the form of a liquid crystal display device and a plasma display panel (PDP). These prior-art display devices are each configured such that a discharge space or a space in which liquid crystals are sealed is defined between a front plate and a rear plate, and electrodes for selecting and driving desired cells are provided on the front plate and the rear plate. In the liquid crystal display device, circuit elements such as TFTs are provided on the rear plate. In the PDP, barrier ribs defining pixels and fluorescent layers formed by applying and firing fluorescent materials are provided on one of the plates.

That is, the liquid crystal display device and the PDP for the prior-art large-screen thin-shaped display devices are each produced by forming the electrodes and the like for the pixels on the front plate or the rear plate, and sealing liquid crystals or a discharge gas and the fluorescent materials in the space defined between the front and rear plates. Thus, a so-called superposing method is employed, in which display function components are sequentially fabricated on a substrate.

In this superposing method, components for the pixels and the electrodes are sequentially formed on the substrate, which serves as a base in the production process until a display panel is finally produced. Therefore, the resulting display panel inevitably has a greater thickness and a greater weight, which make it difficult to flex the display panel.

Besides the liquid crystal display device and the PDP, an EL display device which utilizes the electroluminescent (EL) principle is also known. JP-A-2005-116320 discloses a flexible EL display device which includes an insulative film substrate, electroluminescent elements provided as light emitting elements on the insulative film substrate, and electrodes provided on the insulative film substrate for driving the EL elements. However, the electrodes for the EL display device are also provided on the insulative substrate.

The EL display device is flexible. However, an EL display device production process includes the step of forming the EL elements on the insulative substrate and, therefore, has a significant limitation such that the light emitting portion should be formed after preparation of the insulative substrate.

As described above, the prior-art thin-shaped display devices are produced through the superposing method by forming the light emitting elements or the light emitting portion integrally with the substrate. Therefore, the substrate to be used has a thickness that is too great to flex the display panel. Further, the prior-art thin-shaped display devices have a significant limitation such that the display panels should be produced by a sequential process.

Patent Document 1: JP-A-2005-116320

### DISCLOSURE OF THE INVENTION

### Problems to be Solved by the Invention

As described above, it is difficult to flex the display panels of the prior-art thin-shaped display devices. Further, the large-screen thin-shaped display devices are too heavy, thereby minimizing the degree of freedom in the production of the display panels. It is therefore an object of the present invention to solve these problems.

### Means for Solving the Problems

To solve the aforementioned problems, the inventors of the present invention conducted intensive studies and, as a result, conceived a technical idea of separately producing a light emitting portion of a display device and an electrode board including electrodes for causing a desired part of the light emitting portion to emit light, and combining the light emitting portion with the electrode board with the use of an adhesive, by pressure or by suction. Based on this idea, a thin-shaped display device which is free from the aforementioned problems is provided. With the light emitting portion and the electrode board provided as separate members, it is possible to use a thin substrate for the formation of the light emitting portion and to widen the choices of substrate materials (e.g., having different heat resistances) for the electrode board to be separately produced. Therefore, a flexible material such as polyethylene terephthalate (PET) can be used as the substrate material. Accordingly, the light emitting portion and the electrode board are imparted with flexibility, so that a flexible display device can be provided. Further, the light emitting portion and the electrode board can be separately produced, thereby eliminating the limitation that the light emitting portion should be fabricated after the production of the electrode board. The light emitting portion, the electrode board and other components can be individually evaluated for quality, and individually screened for defective. This improves the yield, and effectively reduces the costs as compared with the prior-art sequential production process.

According to one aspect of the present invention to solve the aforementioned problems, there is provided a display device, which includes: a light emitting portion including a light emitting layer, a front plate provided on a front side of the light emitting layer, and a rear plate provided on a rear side of the light emitting layer; and an electrode board having an electrode which applies a voltage to the light emitting layer; wherein the electrode board is flexible and is disposed on at least one of the front plate and the rear plate.

The electrode board preferably includes electrode boards respectively provided on a front side and a rear side of the light emitting portion. The electrode board may be bonded to the light emitting portion via an adhesive layer.

According to another aspect of the present invention, there is provided a display device, which includes: a light emitting portion including a light emitting layer having a discharge gas and a fluorescent layer, a front plate provided on a front side of the light emitting layer, and a rear plate provided on a rear side of the light emitting layer; a front electrode board provided on the front plate and having an electrode; and a rear electrode board provided on the rear plate and having an electrode; wherein at least one of the front electrode board and the rear electrode board is flexible.

The front electrode board preferably includes a plurality of sustain electrode pairs, and the rear electrode board preferably includes a plurality of address electrodes, whereby a tri-electrode surface discharge PDP is provided.

According to further another aspect of the present invention, there is provided a display device, which includes: a light emitting module including a plurality of light emitting portions two-dimensionally arrayed in adjoining relation; a front electrode board provided on a front side of the light emitting module and having electrodes; and a rear electrode board provided on a rear side of the light emitting module and having electrodes; wherein adjacent ones of the light emitting portions contact each other.

With this arrangement, a large screen can be easily provided by arraying a plurality of light emitting portions.

The front plate provided on the front side of the light emitting layer and the rear plate provided on the rear side of the light emitting layer are preferably glass plates, and each have a thickness of about 0.2 mm, preferably not greater than 0.1 mm for flexibility of the light emitting portion, and preferably not less than 30 μm for sufficient strength for the formation of the light emitting layer.

### EFFECTS OF THE INVENTION

In the display devices of the present invention, the light emitting portion and the electrode board including the electrode for driving the light emitting portion for light emission are provided as separate members. This allows the light emitting portion to have a smaller thickness, and widens the choices of substrate materials for the electrode board. Therefore, a flexible material can be employed as the substrate material, thereby imparting the display devices with flexibility. Further, the light emitting portion and the electrode board can be separately produced, so that the degree of freedom is increased in the production of the display devices. Therefore, the light emitting portion and the electrode board can be produced in different steps or in different production lines. Further, the light emitting portion, the electrode board and other components can be individually evaluated for quality, thereby reducing the production costs of the display devices. In addition, a large screen can be easily produced by arraying a plurality of light emitting portions.

### BRIEF DESCRIPTION OF THE DRAWINGS

FIG. 1 is a diagram showing the basic construction of a display device including light emitting layers formed by using inorganic fluorescent materials according to the present invention.

FIG. 2 is a diagram schematically illustrating a display device which is configured such that electrode boards are bonded to a light emitting portion via adhesive layers.

FIG. 3 is a diagram schematically illustrating a display device including a light emitting portion which includes light emitting layers that utilize gas discharge.

FIG. 4 is a diagram showing the configuration of a thin-shaped display device including a light emitting portion which includes light emitting layers that utilize gas discharge.

FIG. 5 is a diagram illustrating components of the light emitting portion.

FIGS. 6A to 6D are diagrams schematically showing a production process for producing the light emitting portion in a vacuum chamber.

FIG. 7 is a diagram schematically showing the appearance of the light emitting portion.

FIG. 8 is a diagram schematically illustrating a light emitting module including a plurality of light emitting portions.

FIG. 9 is a diagram showing a positional relationship among the light emitting module, a front electrode board and a rear electrode board.

FIG. 10 is a diagram showing a positional relationship between a junction of the light emitting portions and a non-light-emitting region.

FIG. 11 shows diagrams schematically showing the geometry of a partition frame to be used for the light emitting portion.

FIG. 12 shows diagrams showing the sectional shapes of exemplary partition frames.

FIG. 13 shows diagrams showing a light emitting portion configured such that fluorescent chips are respectively provided in grooves of the partition frame.

### BEST MODE FOR CARRYING OUT THE INVENTION

Preferred embodiments of the present invention will hereinafter be described.

### First Embodiment

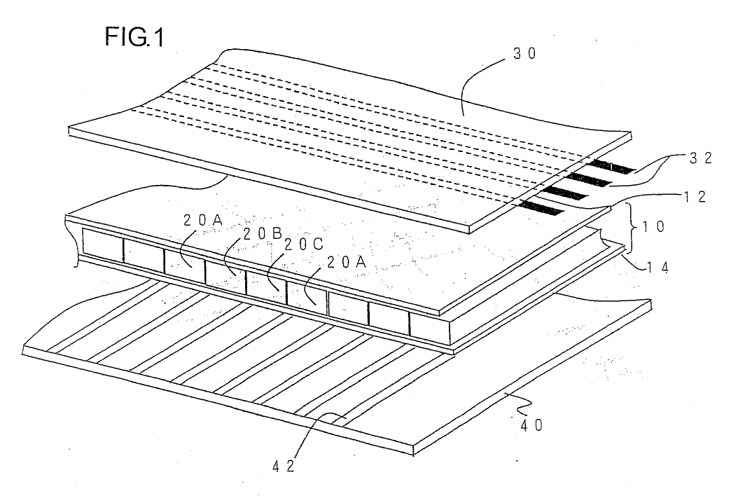

FIG. 1 is a diagram showing a basic construction according to the present invention. A light emitting portion 10 includes light emitting layers 20A, 20B, 20C which, for example, respectively emit red light, green light and blue light, and plates 12, 14 respectively provided on a front side and a rear side of the light emitting layers 20A, 20B, 20C. The light emitting layers 20A, 20B, 20C are formed on one of the plates 12, 14 by a printing method. Of these light emitting layers, the light emitting layers 20A are fluorescent layers formed, for example, by using ZnS:Sm, Cl and ZnS:Mn as a base material. Further, the light emitting layers 20B are fluorescent layers formed, for example, by using ZnS:Tb, F and CaS:Ce as a base material, and the light emitting layers 20C are fluorescent layers formed, for example, by using ZnS:Tm and F as a base material. Exemplary materials for the plates 12, 14 include inorganic insulative materials such as glass. Particularly, a material such as ceramic which is impervious to light may be used for the plate disposed on the rear side. The plates 12, 14 may each function as an insulative layer or a dielectric layer and, in this case, BaTiO₃ or Ta₂O₅ may be used as a material for the plates 12, 14. Where glass plates are used, the glass plates preferably each have a thickness not greater than 0.2 mm for flexibility of the light emitting portion 10, and more preferably have a thickness not greater than 0.1 mm and not less than 30 μm for higher flexibility and sufficient strength for the production.

In FIG. 1, a board 30 is provided on the front side of the light emitting portion 10. The board 30 includes electrodes 32 provided in contact with the light emitting portion 10 as extending perpendicularly to the light emitting layers 20A, 20B, 20C. On the other hand, a board 40 is provided on the rear side of the light emitting portion 10. The board 40 includes electrodes 42 provided in contact with the light emitting portion 10 as extending along the light emitting layers 20A, 20B, 20C.

The board 30 is pervious to light, and preferably permits formation of an ITO film or a NESA film thereon for formation of transparent electrodes as the electrodes 32. The board 30 is preferably a polyethylene terephthalate (PET) film having a thickness of about 120 μm. On the other hand, the board 40 may be a PET film, but is not necessarily required to be pervious to light. The electrodes 42 are not necessarily required to be pervious to light and, therefore, may be formed by a plating method or by a printing method employing an electrically conductive paste. Alternatively, the electrodes 42 may be formed in a desired pattern by bonding a metal layer such as a copper foil on the substrate and etching the metal layer. The pitches of the electrodes 32 and the electrodes 42 and the pitches of the light emitting layers 20A, 20B, 20C may be properly determined depending on the viewing distance and the size of a display screen, and the size of each pixel. The light emitting layers 20A, 20B, 20C preferably each have a thickness of about 30 μm, for example, but the thickness of the light emitting layers 20A, 20B, 20C may be properly determined depending on a driving voltage and light intensity.

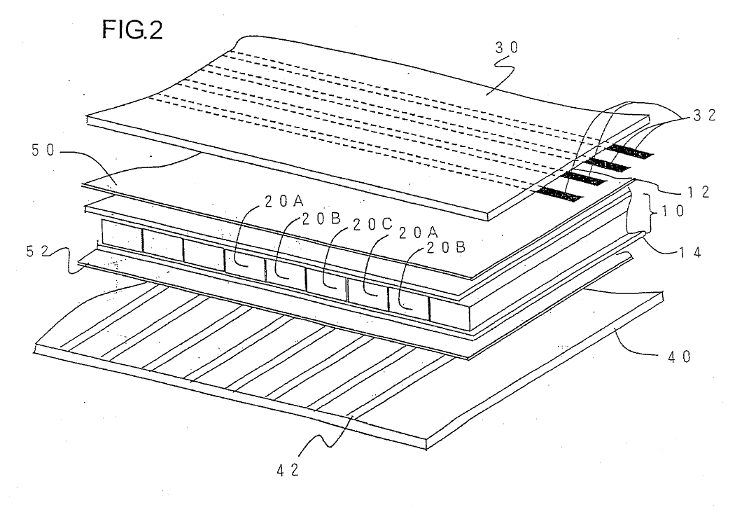

In FIG. 2, components having the same functions as those shown in FIG. 1 will be denoted by the same reference characters as in FIG. 1, and duplicate description of these components will be omitted. FIG. 2 is a diagram illustrating the board 30 and the board 40 to be bonded to the light emitting portion 10 with an adhesive layer 50 and an adhesive layer 52. The adhesive layer 50 is preferably composed of an epoxy resin or a photo-curable resin which is pervious to light and soft at ordinary temperatures. Similarly, the adhesive layer 52 is preferably composed of an epoxy resin or a photo-curable resin which is soft at ordinary temperatures. Alternatively, a common adhesive film may be used.

Further, a liquid adhesive agent or an adhesive sheet may be used for the adhesive layers 50, 52 shown in FIG. 2. Further, the plate 12 and the plate 14 may be electrostatically bonded to the board 30 and the board 40, respectively, by electrifying the plates 12, 14 and the boards 30, 40. This method is particularly effective where the light emitting portion 10 has a greater area. Alternatively, the plate 12 and the plate 14 may be bonded to the board 30 and the board 40, respectively, by pressing the boards 30, 40 against the plates 12, 14 into intimate contact with the plates 12, 14 by atmospheric pressure. Further, different bonding methods may be used for the bonding on the front side and on the rear side. For example, only the peripheral surface portions of the light emitting portion 10 are bonded to the boards 30, 40 with an epoxy resin, and any of the aforementioned bonding methods may be used for bonding the other surface portions of the light emitting portion 10.

### Second Embodiment

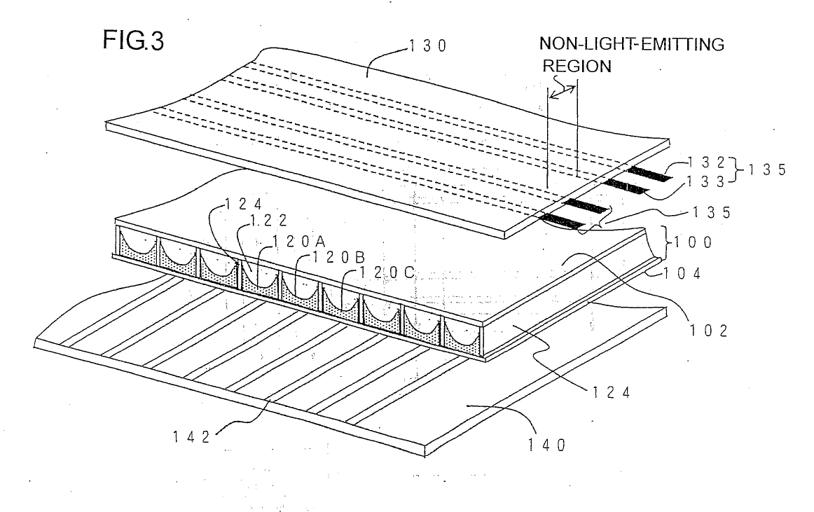

With reference to FIG. 3, a display device will be next described, which includes a light emitting portion utilizing gas discharge. In FIG. 3, the light emitting portion 100 includes a front plate 102, a rear plate 104, and ribs 124 provided between the front plate 102 and the rear plate 104. A discharge gas 122 is sealed in spaces defined between the respective ribs 124, and fluorescent layers 120A, 120B, 120C are sequentially provided in the spaces. The fluorescent layers 120A, 120B, 120C emit red light, green light and blue light, respectively. The front plate 102 and the rear plate 104 are preferably glass plates each having a thickness not greater than 0.1 mm and not less than 30 μm, like the plates 12, 14 shown in FIGS. 1 and 2. The front plate 102 is preferably a glass plate pervious to light. However, the rear plate 104 is not necessarily required to be pervious to light, but may be a pigment-containing glass plate. Though not shown, a protective film such as an HgO film is provided over the front plate 102 and surfaces of the ribs 124 which contact the discharge gas 122.

A front electrode board 130 is disposed on the front plate 102, and includes sustain electrode pairs 135 each including electrodes 132, 133 provided on a surface thereof in contact with the plate 102 as extending perpendicularly to the lengths of the fluorescent layers 120A, 120B, 120C. A non-light-emitting region 137 having a width that is greater than a distance between the electrodes 132 and 133 is present between each two adjacent sustain electrode pairs 135. A rear electrode board 140 is provided on the rear plate 104, and includes address electrodes 142 provided on a surface thereof in contact with the rear plate 104 as extending along the fluorescent layers 120A, 120B, 120C.

Like the front plate 102, the front electrode board 130 is preferably pervious to light, and permits formation of an ITO film or a NESA film thereon for formation of transparent electrodes as the electrodes 132. The substrate for the electrode board 130 is preferably a polyethylene terephthalate (PET) film having a thickness of about 120 μm. On the other hand, a substrate for the rear electrode board 140 may be a PET film, but is not necessarily required to be pervious to light. The address electrodes 142 are not necessarily required to be pervious to light and, therefore, may be formed by a plating method or by a printing method employing an electrically conductive paste. Alternatively, the address electrodes 142 may be formed in a desired pattern by bonding a metal layer such as a copper foil on the substrate and etching the metal layer.

In FIG. 3, a method for bonding the light emitting portion 100 to the front electrode board 130 and the rear electrode board 140 is not shown, but any of the bonding methods described with reference to FIG. 2 may be used for the bonding.

The following arrangements are also possible as in the embodiments described above with reference to FIGS. 1 to 3.

(1) A display device including a light emitting portion which includes light emitting layers composed of light emitting substances of inorganic materials and plates each having no display electrode, and an electrode board provided in contact with at least one side of the light emitting portion and including electrodes for applying voltages to the light emitting portion, wherein the light emitting portion and the electrode board are provided as independent members, wherein the electrode board is composed of an organic material for flexibility.
(2) A display device including a light emitting portion composed of inorganic materials, and an electrode board provided in contact with at least one side of the light emitting portion and including electrodes for applying voltages to the light emitting portion, wherein the light emitting portion includes a plate having a minimum thickness not greater than 0.1 mm, and light emitting layers provided on the plate, wherein the electrode board is flexible.
(3) A display device including a light emitting portion composed of inorganic materials, and electrode boards provided in contact with opposite sides of the light emitting portion and each including electrodes for applying voltages to the light emitting portion, wherein the light emitting portion includes a plate having a thickness not greater than 0.1 mm, and light emitting layers provided on the plate, wherein the electrode boards are flexible, and at least one of the electrode boards is pervious to light.
(4) A display device including a light emitting portion composed of inorganic materials, and an electrode board provided in contact with at least one side of the light emitting portion and including electrodes for applying voltages to the light emitting portion, wherein the light emitting portion includes a thin plate and light emitting layers provided on the plate, wherein an adhesive layer is provided between the light emitting portion and the electrode board, wherein the electrode board is flexible.
(5) A display device including a light emitting portion composed of inorganic materials, and electrode boards provided in contact with opposite sides of the light emitting portion and including electrodes for applying voltages to the light emitting portion, wherein the light emitting portion includes a thin plate and light emitting layers provided on the plate, wherein adhesive layers are provided between the light emitting portion and the electrode boards, wherein the electrode boards are flexible, and at least one of the electrode boards is pervious to light.
(6) Any of the aforementioned display devices, in which the light emitting layers each include a discharge gas and a fluorescent layer.
(7) Any of the aforementioned display devices, in which the light emitting portion includes fluorescent layers and a dielectric plate.
(8) A display device production method for producing a display device including a light emitting portion which includes light emitting layers composed of light emitting substances of inorganic materials and a plate having no electrode, and an electrode board which is flexible and provided in contact with at least one side of the light emitting portion and includes electrodes for applying voltages to the light emitting portion, the method including the steps of: independently producing the light emitting portion and the electrode board; and combining the electrode board with the light emitting portion.
(9) A display device production method for producing a display device including a light emitting portion composed of inorganic materials, and an electrode board provided in contact with at least one side of the light emitting portion and including electrodes for applying voltages to the light emitting portion, the method including the steps of: preparing a plate having a minimum thickness not greater than 0.1 mm for the light emitting portion; forming light emitting layers on the plate; and combining a flexible electrode board with the resulting light emitting portion.
(10) A display device including a light emitting portion composed of inorganic materials, and electrode boards provided in contact with opposite sides of the light emitting layer and including electrodes for applying voltages to the light emitting layer, wherein the light emitting layer includes a plate having a thickness not greater than 0.1 mm and a light emitting portion provided on the plate, wherein at least one of the electrode boards is pervious to light.

### Third Embodiment

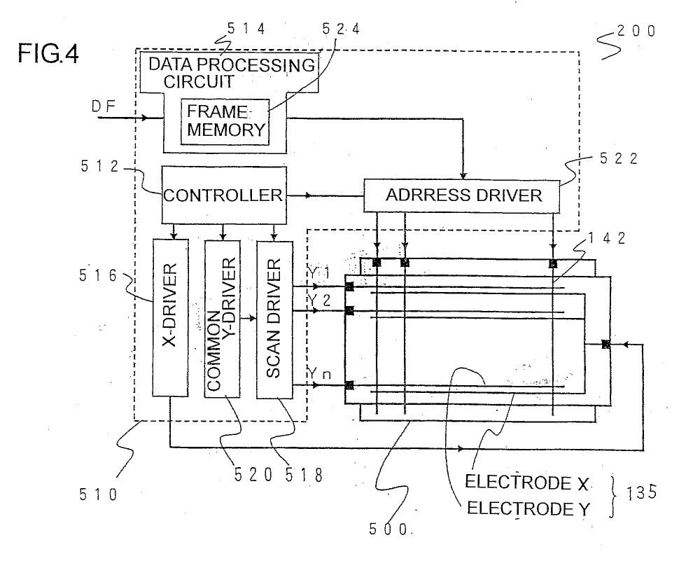

In FIG. 4, a display device 200 is shown which employs the thin-shaped display device shown in FIG. 3 and a peripheral circuit in combination.

In this embodiment, the display device 200 is connected to a drive unit 500. Sustain electrode pairs 135 each extend along a line of a display screen, and each include a scan/sustain electrode Y and a sustain electrode X. Regions at which the sustain electrode pairs 135 and the address electrodes 142 intersect each other are each referred to as a cell. The scan/sustain electrode Y serves as a scan electrode for selecting a line of cells when a cell to be caused to emit light by electric discharge by the sustain electrode pair 135 is selected. The address electrodes 142 each extend along a column of the display screen, and serve for selecting a column of cells. The drive unit 500 includes a controller 512, a data processing circuit 514, an X-driver 516, a scan driver 518, a common Y-driver 520, an address driver 522 and a power source circuit not shown. Pixel-based field data DF indicating a luminance level (gradation level or, in the case of full-color display, RGB luminance levels) is inputted together with synchronization signals to the drive unit 500 from an external device such as a TV tuner or a computer. The field data DF is once stored in a frame memory 524 in the data processing circuit 514, and then processed for gradation display. The processed data is stored in the frame memory 524, and transferred to the address driver 522 in proper timing.

The X-driver 516 applies a drive voltage to all the sustain electrodes X. The scan driver 518 individually applies a drive voltage to the scan/sustain electrodes Y for selecting cells. The common Y-driver 520 applies a drive voltage to the respective scan/sustain electrodes Y at a time for sustaining light emission at the selected cells.

### Fourth Embodiment

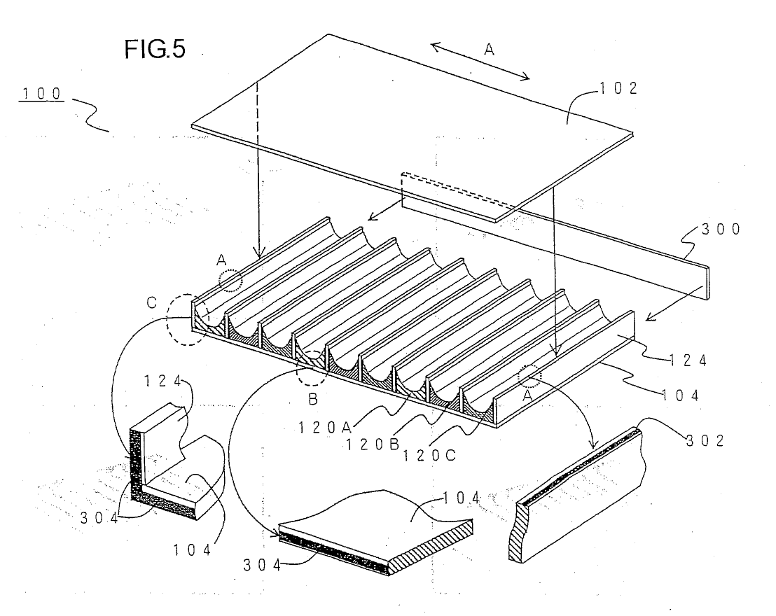

With reference to FIGS. 5 to 7, a method for producing a light emitting portion according to the present invention will be described. In FIGS. 5 to 7, components having the same functions as those shown in FIGS. 1 to 3 will be denoted by the same reference characters as in FIGS. 1 to 3, and duplicate description of these components will be omitted. FIGS. 5 to 7 illustrate a thin-shaped display device which has a structure similar to that of a surface discharge tri-electrode PDP. FIG. 5 is a diagram schematically illustrating a light emitting portion 100. In this embodiment, glass substrates are employed as a front plate 102, a rear plate 104, ribs 124 and end plates 300. In FIG. 5, only one end plate 300 is shown, but another plate 300 not shown is provided on a forward side. The ribs 124 are provided on the rear plate 104 to separate fluorescent layers 120A, 120B, 120C from each other and to space the front plate 102 and the rear plate 104 from each other. Alternatively, the ribs 124 may be provided on the front plate 102. The front plate 102, the rear plate 104, the ribs 124 and the end plates 300 preferably each have a thickness not greater than 0.1 mm and not less than 30 μm. Particularly, the ribs 124 may have a thickness of about 0.2 mm, because the ribs 124 rarely influence the flexibility of the light emitting portion 100 with respect to arrow directions A. The ribs 124 preferably each have a height of 50 to 200 μm, but the height may be properly selected depending on the intensity of light desired to be emitted and voltages to be applied. The ribs 124 may be bonded to the rear plate 104 with low-melting-point glass. Where the ribs 124 and the rear plate 104 are unitarily provided, a sand-blast method or an etching method conventionally known may be employed. Further, a bonding method using low-melting-point glass may be employed for bonding the ribs 124 to the rear plate 104. The ribs 124 may be formed by directly shaping softened glass by a stamping method or a replica method, or by forming a preform of matrix glass having a generally conformable shape, and softening and reforming the preform by a download method or a redraw method.

In this embodiment, the ribs 124 are unified with the rear plate 104, and predetermined amounts of fluorescent materials 120A, 120B, 120C are applied into spaces between the ribs 124 and dried. Then, a sealant 302 (e.g., LSS-3075 available from Nippon Electric Glass Co., Ltd.) is applied on top portions of endmost ones of the ribs 124 located at opposite ends of the light emitting portion 100. At this stage, the front plate 102 is positioned with respect to the endmost ribs 124 in superposed relation, and then the sealant 302 is fused to bond the front plate 102 to the ribs 124. However, it is further preferred that the bonding is achieved in a vacuum chamber as will be described later. The front plate 102 may be bonded not only to the top portions of the endmost ribs 124 but also to top portions of the other ribs 124. The sealant 302 may be applied to the entire regions of the top portions of the ribs 124, but is preferably applied to widthwise parts of the top portions of the ribs 124 as shown in FIG. 5 for prevention of intrusion of the sealant 302 into the fluorescent material 120C. At this stage, a sealant 304 is applied to edges (forward edges and backward edges) of the rear plate 104 and edges (four edges) of the endmost ribs 124 as shown in broken line circles B, C in FIG. 5.

At this stage, the end plates 300 of the light emitting portion 100 are not bonded to the front plate 102, the rear plates 104 and the endmost ribs 124.

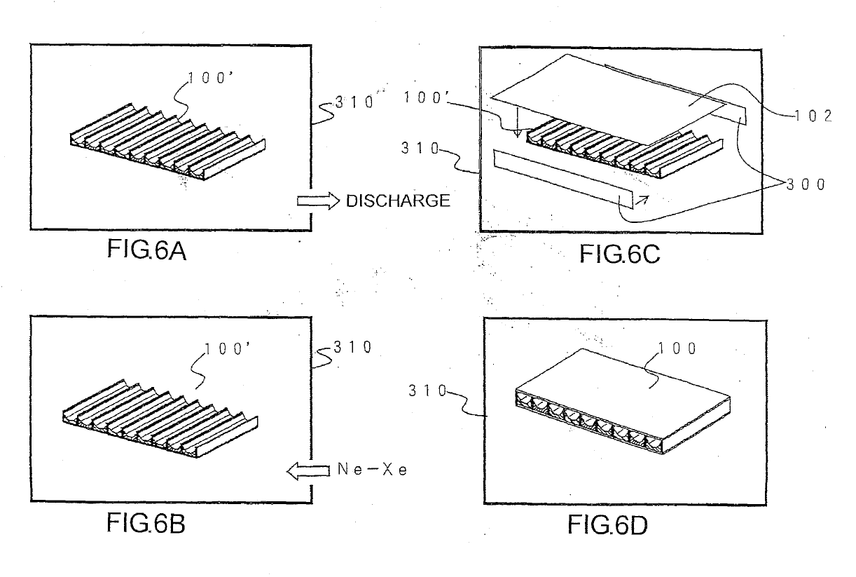

After the application of the sealant 304, a light emitting portion 100′ yet to be bonded to the front plate 102 and the end plates 300 as shown in FIG. 6A is placed in a vacuum chamber 310, which is in turn evacuated for removal of gases and moisture from the light emitting portion 100′. Then, as shown in FIG. 6B, a discharge gas is introduced into the vacuum chamber 310 from a gas cylinder not shown through a pipe. In this embodiment, a mixture of neon gas and xenon gas (Ne—Xe gas) is used as the discharge gas.

After the light emitting portion 100′ is filled with the discharge gas, the front plate 102 and the two end plates 300 are bonded to an upper surface and opposite end faces (forward and backward end faces) of the unsealed light emitting portion 100 with the use of the sealant 304 as shown in FIG. 6C. Thus, the light emitting portion 100 is perfectly sealed. The two end plates 300 are bonded to the light emitting portion 100 in the vacuum chamber 310. As shown in FIG. 6C, the end plates 300 are automatically moved toward the light emitting portion 100′ and pressed against the light emitting portion 100′ by a known technique. Then, the internal temperature of the vacuum chamber 310 is kept at the melting point of the sealant 304 for a predetermined period, and then the vacuum chamber 310 is cooled. Thus, the end plates 300 are easily bonded to the light emitting portion 100′. The resulting light emitting portion 100 after the sealant 304 is solidified is shown in FIG. 6D.

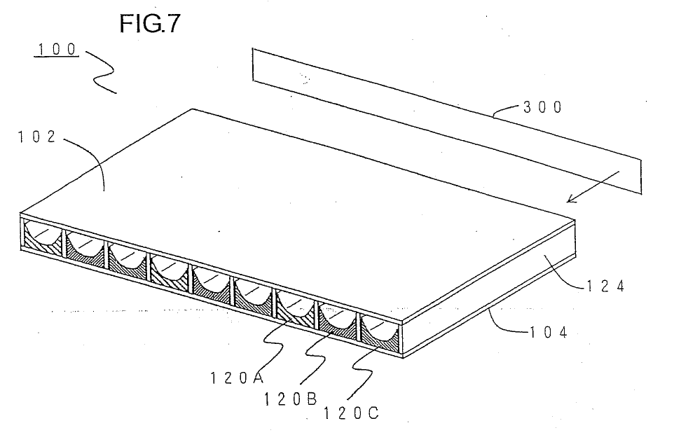

The appearance of the light emitting portion 100 thus produced is shown in FIG. 7.

### Fifth Embodiment

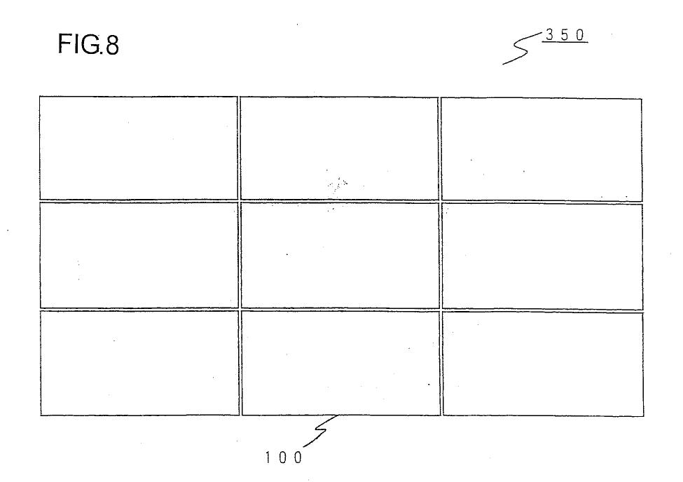

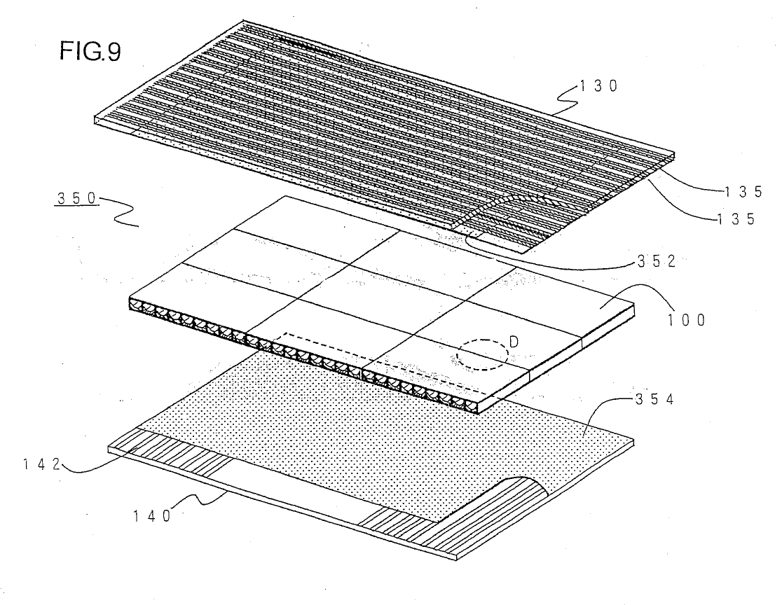

With reference to FIGS. 8 to 10, a fifth embodiment will be described. FIG. 8 illustrates nine light emitting portions 100 two-dimensionally arrayed. FIG. 9 shows how to locate electrode boards on opposite surfaces of a light emitting module 350 including an array of the nine light emitting portions 100. In FIGS. 8 to 10, components having the same functions as those shown in FIG. 3 will be denoted by the same reference characters as in FIG. 3, and duplicate description of these components will be omitted.

While the light emitting portion 100, the front electrode board 130 and the rear electrode board 140 are partly shown in FIG. 3, the light emitting module 350 including the nine light emitting portions 100 is shown in FIG. 9. An adhesive layer 352 having the same plan size as the light emitting module 350 is provided on a surface of the front electrode board 130 (a rear surface of the illustrated front electrode board 130) to be brought into contact with a front surface of the light emitting module 350.

On the other hand, an adhesive layer 354 is provided on a surface of the rear electrode board 140 to be brought into contact with a rear surface of the light emitting module 350. The adhesive layer 354 has substantially the same plan size as the light emitting module 350.

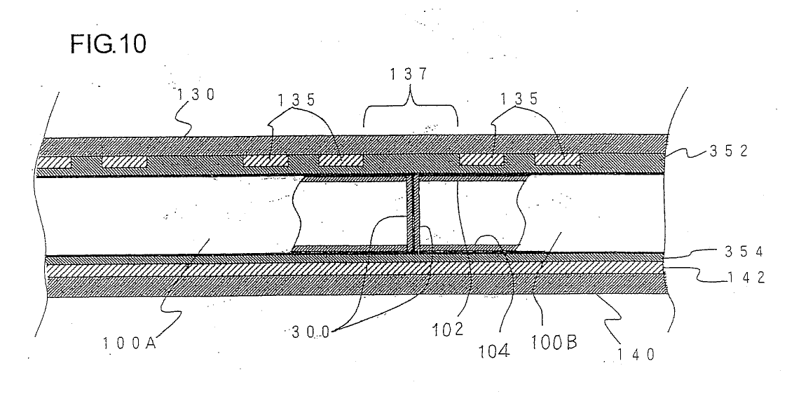

The front electrode board 130 and the rear electrode board 140 are bonded to the light emitting module 350. A portion of a junction between adjacent ones of the light emitting portions 100 as shown in a broken line circle D after the bonding is shown in greater detail in FIG. 10. In FIG. 10, the light emitting portion 100A and the light emitting portion 100B are disposed with their end plates 300 bonded to each other. The front electrode board 130 is bonded to the light emitting module 350 so that a junction between the end plates 300 is located along a center line of a non-light-emitting region 137 defined between adjacent sustain electrode pairs 135.

In this manner, the end plates 300 at which light emission does not occur are aligned with the non-light-emitting region 137, so that boundaries of the arrayed light emitting portions 100 are not used for display. Therefore, even if a plurality of inventive light emitting portions 100 are arrayed for use, boundaries of the arrayed light emitting portions 100 are not visible. This makes it possible to easily produce a greater size display screen without inconsistency.

### Sixth Embodiment

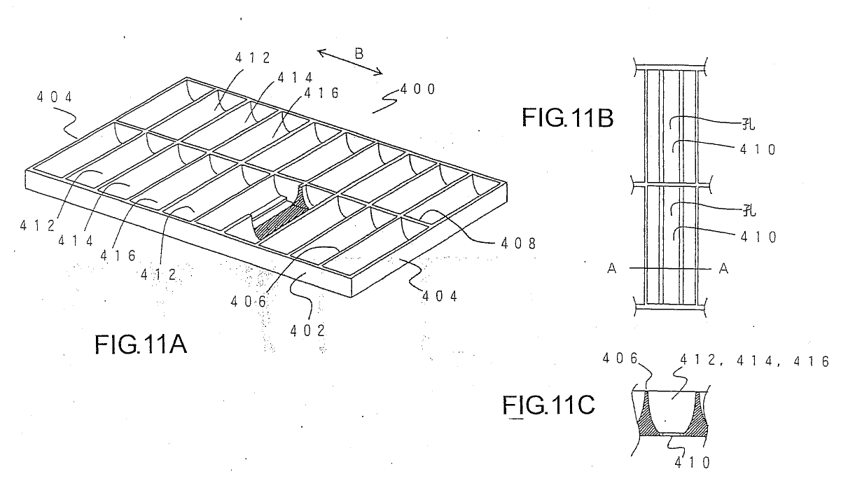

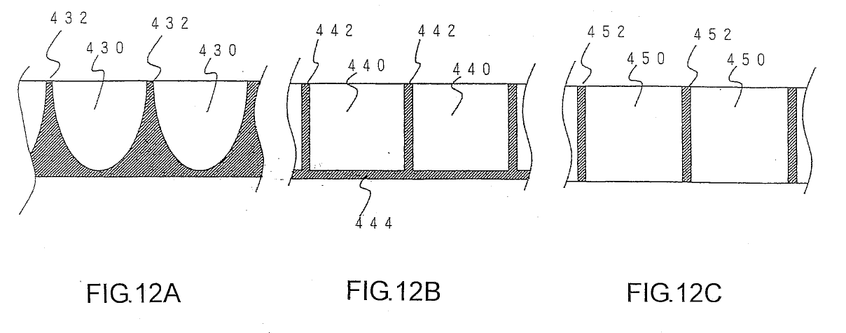

With reference to FIG. 11 and FIG. 12, components to be used for the light emitting portion 100 will be described. In this embodiment, a smaller number of components are used to form the ribs 124 present between the fluorescent layers 120A, 120B, 120C of the light emitting portion 100 shown in FIG. 3 and to form the end plates 300 of the light emitting portion 100 shown in FIG. 5.

FIG. 11A is a perspective view of a partition frame 400 which is configured such that the ribs 124 of the light emitting portion 100 and the end plates 300 shown in FIG. 5 are unified. The view direction of the partition frame 400 is the same as that in FIG. 5. In FIG. 11A, red, green and blue light emitting fluorescent materials are applied into grooves 412, 414, 426, respectively. The partition frame 400 may be configured such that grooves shown in FIG. 11A have the same width as measured in arrow directions B. Alternatively, the grooves may have different widths such that grooves into which a fluorescent material having a higher light emitting efficiency (light intensity) is applied each have a smaller width, and grooves into which a fluorescent material having a lower light emitting efficiency (light intensity) is applied each have a greater width.

Where the grooves have different widths, a pitch between adjacent grooves 412 and 414, a pitch between adjacent grooves 414 and 416, and a pitch between adjacent grooves 416 and 412 may be different or may be the same.

In FIG. 11A, the grooves are arrayed in a 10×2 matrix by way of example, but the number of columns is preferably a number represented by 3×(a power of 2). In FIG. 11A, a partition 408 is provided, but may be omitted. Further, a multiplicity of partitions 408 may be provided corresponding to the number of pixels to be provided in the display device. That is, the grooves may be provided in a honeycomb pattern for the respective pixels. The partition frame 400 includes ribs 406 disposed between the grooves 412, 414, 416, and frame portions 404, 406 provided on the periphery of the partition frame 400. FIG. 11B is a partial plan view of the partition frame 400 shown in FIG. 11A. FIG. 11C shows a section taken along a line A-A in FIG. 11B. As shown in FIG. 11C, the ribs 416 between which the grooves 412, 414, 416 are defined each have a skirt-shaped cross section. The skirt-shaped smooth ribs reduce the amount of the fluorescent materials to be applied thereon, and permit easy application of the fluorescent materials to the bottoms of the grooves. Exemplary shapes of the grooves of the partition frame 400 are shown in FIGS. 12A, 12B and 12C as corresponding to the sectional shape shown in FIG. 11C. In FIG. 12A, grooves 430 are each formed by connecting the bottoms of partition walls (or ribs) 432, and each have a concave sectional shape. In FIG. 12B, grooves 440 each have a sectional shape such that partition walls (or ribs) 442 are perpendicular to a bottom portion 444. In the case of the grooves 430, 440, bottom gaps 410 as shown in FIG. 11C are covered and, therefore, the rear plate 104 shown in FIG. 5 may be obviated.

On the other hand, grooves 450 shown in FIG. 12C each have a sectional shape such as to be defined between adjacent partitions 452 with their bottoms uncovered. Therefore, when the fluorescent materials are applied or when the vacuum chamber 310 shown in FIG. 6A is evacuated, defoaming can be easily achieved.

### Seventh Embodiment

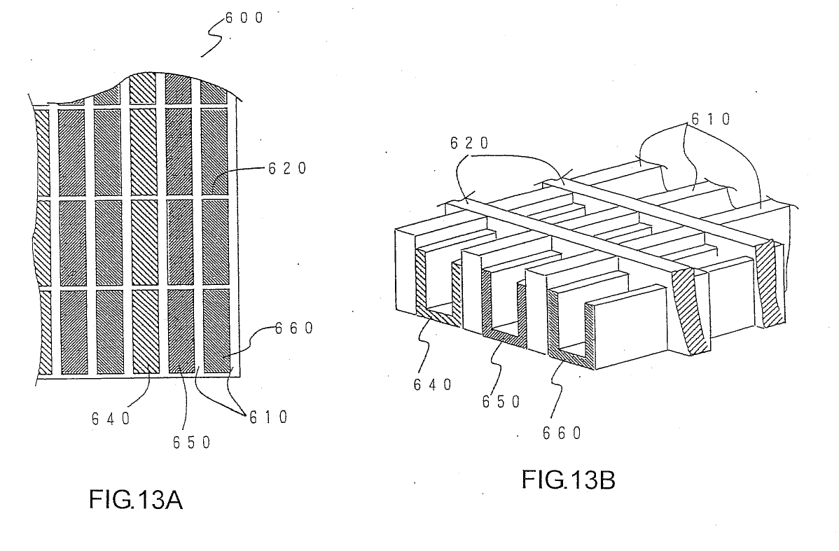

According to the seventh embodiment, the components of the light emitting portion 100 shown in FIG. 5 and the like are provided as separate members produced in different steps. FIG. 13 shows plan views illustrating a light emitting layer 600 which includes a partition frame 602 having grooves conformable to the shapes of the respective color pixels as corresponding to the partition frame 400 shown in FIG. 11A, and red fluorescent chips 660, green fluorescent chips 650 and blue fluorescent chips 660 produced separately from the partition frame 602 as each having a concave cross section and fitted in the grooves of the partition frame 602. The partition frame 602 includes partition portions 610, 620. FIG. 13B is a perspective view partly illustrating the light emitting portion 600 shown in FIG. 13A. The fluorescent chips 640, 650, 660 are each illustrated as having a concave cross section, but may each have a planar shape such as to be fitted in the bottom thereof as seen in plan in FIG. 13A. The fluorescent chips 640, 650, 660 may each have a U-shaped cross section rather than the concave cross section. As shown in FIG. 13A, the fluorescent chips 640, 650, 660 may be arranged so that the same color fluorescent chips are aligned in a column direction, or may be arranged so that the red, green and blue fluorescent chips are sequentially aligned in a column direction.

As described above, the fluorescent materials are provided in the form of the fluorescent chips 640, 650, 660, which are respectively fitted in the grooves of the partition frame 602 or bonded in the grooves. Therefore, the fluorescent chips can be produced under optimum conditions. Further, a large display screen can be easily produced by arraying a greater number of fluorescent chips without reducing the yield without performing a lower yield process for uniformly applying the fluorescent materials onto a large display screen area. In the prior art, the respective color fluorescent materials are applied on the same substrate and, therefore, are liable to be mixed with each other, thereby deteriorating the display quality. In the present invention, on the contrary, the respective fluorescent chips are separately produced, so that problems associated with the mixing of the fluorescent materials are eliminated.

### INDUSTRIAL APPLICABILITY

The light emitting portion and the electrode board including the electrodes for driving the light emitting portion for light emission are provided as separate members. This allows the light emitting portion to have a smaller thickness and a lighter weight, and widens the choices of substrate materials for the electrode board. Therefore, a flexible material can be used for the electrode board, thereby imparting the display device with flexibility. Further, the light emitting portion and the electrode board can be separately produced, so that the degree of freedom is increased in the production of the display device. Therefore, the light emitting portion and the electrode board can be produced in different steps or in different production lines. Further, the light emitting portion, the electrode board and other components can be individually evaluated for quality, thereby reducing the production costs of the display device.

### DESCRIPTION OF REFERENCE CHARACTERS

10: Light emitting portion
12: Front plate
20: Light emitting layer
30: Board
32: Electrodes
40: Board
42: Electrodes
50: Adhesive layer
52: Adhesive layer
100: Light emitting portion
102: Front plate
104: Rear plate
120: Fluorescent material
122: Discharge gas
124: Ribs
135: Sustain electrode pairs
142: Address electrodes
200: Display device
300: End plates
302: Sealant
304: Sealant
350: Light emitting module
352: Adhesive layer
354: Adhesive layer
400: Partition frame
412, 414, 416: Grooves
602: Partition frame
640, 650, 660: Fluorescent chips

1. A thin-shaped display device comprising:
a light emitting portion including a light emitting layer, a front plate provided on a front side of the light emitting layer, and a rear plate provided on a rear side of the light emitting layer;
wherein the thin shaped display includes
an electrode board having an electrode which applies a voltage to the light emitting layer; and
wherein the electrode board is flexible and is disposed on at least one of the front plate and the rear plate.

2. A thin-shaped display device as set forth in claim 1, wherein the electrode board includes electrode boards respectively provided on a front side and a rear side of the light emitting portion.

3. A thin-shaped display device as set forth in claim 1, wherein the electrode board is bonded to the light emitting portion via an adhesive layer.

4. A thin-shaped display device as set forth in claim 1, wherein the light emitting portion includes a fluorescent material.

5. A thin-shaped display device comprising:
a light emitting portion including a light emitting layer having a discharge gas and a fluorescent layer, a front plate provided on a front side of the light emitting layer, and a rear plate provided on a rear side of the light emitting layer;
wherein the thin shaped display device includes a front electrode board provided on the front plate and having an electrode; and a rear electrode board provided on the rear plate and having an electrode; and
wherein at least one of the front electrode board and the rear electrode board is flexible.

6. A thin-shaped display device as set forth in claim 5, wherein the front electrode board includes a plurality of sustain electrode pairs, wherein the rear electrode board includes a plurality of address electrodes.

7. A thin-shaped display device comprising:
a light emitting module including a plurality of light emitting portions two-dimensionally arrayed in adjoining relation;
wherein the thin shaped display includes
a front electrode board provided on a front side of the light emitting module and having electrodes; and a rear electrode board provided on a rear side of the light emitting module and having electrodes; and
wherein adjacent ones of the light emitting portions contact each other.

8. A thin-shaped display device, wherein at least one of the front electrode and the rear electrode is flexible.

9. A thin-shaped display device as set forth in claim 7, wherein the light emitting portions each include a light emitting layer having a discharge gas and a fluorescent layer, a front plate provided on a front side of the light emitting layer, and a rear plate provided on a rear side of the light emitting layer.

10. A thin-shaped display device as set forth in claim 7, wherein the front electrode board includes a plurality of sustain electrode pairs, wherein the rear electrode board includes a plurality of address electrodes.

11. A thin-shaped display device as set forth in claim 10, wherein ones of the light emitting portions aligned perpendicularly to the sustain electrode pairs contact each other.

12. A thin-shaped display device as set forth in claim 1, wherein the light emitting portion includes a partition which divides the light emitting layer to define a plurality of regions.

13. A thin-shaped display device as set forth in claim 12, wherein the light emitting portion includes fluorescent chips each composed of a fluorescent material and respectively provided in the regions defined by the partition.

14. A thin-shaped display device as set forth in claim 12, wherein the partition doubles as the front plate or the rear plate.
